(19) United States
(12) Patent Application Publication
(10) Pub. No.: US 2014/0001777 A1
(43) Pub. Date: Jan. 2, 2014

(54) PUSH-TYPE INTERIOR DOOR HANDLE

(71) Applicant: HYUNDAI MOTOR COMPANY, Seoul (KR)

(72) Inventors: Minseok Choi, Hwaseong-si (KR); Youngwook Song, Hwaseong-si (KR); Kichang Yi, Hwaseong-si (KR)

(73) Assignee: Hyundai Motor Company, Seoul (KR)

(21) Appl. No.: 13/657,089

(22) Filed: Oct. 22, 2012

(30) Foreign Application Priority Data
Jul. 2, 2012 (KR) 10-2012-0071578

(51) Int. Cl. E05B 1/00

(52) U.S. Cl. 292/336.3

(57) ABSTRACT

A interior door handle includes one end portion connected to a door trim to form a hinge point, and a push surface which is pushed down by a finger is formed at a position spaced apart from the hinge point. A push grip is rotated around the hinge point by a force applied to the push surface to release locking of a door latch. As a result, the door is conveniently opened by only one-touch push operation, and, in particular, occupants having a relatively weak joint or finger disability can manipulate the door open by only the one-touch push operation of pressing the push surface down.

### CROSS-REFERENCE TO RELATED APPLICATIONS

The present application claims priority of Korean Patent Application Number 10-2012-0071578 filed Jul. 2, 2012, the entire contents of which application is incorporated herein for all purposes by this reference.

### BACKGROUND OF INVENTION

1. Field of Invention

The present invention relates to an interior door handle; and, particularly, to a push-type interior door handle which is incorporated in a door trim so that a door can be opened by a hand, without pulling it with a finger.

2. Description of Related Art

A vehicle door generally includes outside door handles which can open the door from an outside, and interior door handles which can open the door from an inside.

A door handle has a structure which is hinged to a door panel to release locking of a door latch, which is referred to as a leverage type door handle.

The leverage type door handle employs a ratio of distances from a fulcrum to points of application of forces. A function can be expressed by d1 (distance from the fulcrum to a point of application of input force)×W1 (input force)=d2 (distance from the fulcrum to a point of application of output force)×W2 (output force).

Therefore, when the door is opened, the locking of the door latch can be released by only simple operation of pulling a portion of a door handle with a finger. In the state in which the locking state of the door latch is released, the door can be opened by pulling the door (outside vehicle) or by pushing the door (inside vehicle).

In the outside door handle or interior door handle employing the leverage type, after the locking state of the door latch is first released by operating the door handle with the finger, the door is again pushed or pulled with the hand or an elbow. Therefore, it would be understood from the above-described leverage type that at least two steps in motion are required to open the door.

However, in order to open the door for the leverage type interior door handle, at least two steps in motion are required in which the locking state of the door latch should be first released by operating the door handle with the finger, and then the door is again pulled or pushed with the hand or elbow. As a result, the leverage type interior door handle has an inconvenience in the operation of the door.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a push-type interior door handle in which an interior door handle having a long hinge for unlocking operation of a door latch is formed together with a door trim, and locking of the door latch is released by pushing down a door handle which is formed to be long by the door trim, so as to open the door, so that the door is conveniently opened by only one-touch push operation, and, in particular, occupants having a relatively weak joint or finger disability can manipulate the door open by only the one-touch push operation of pressing a push surface down.

Various aspects of the present invention provide for a push-type interior door handle including a push grip which is arranged along a vertical direction of a door trim forming a door together with an outer panel and an inner panel, wherein one end portion is connected to the door trim to form a hinge point, and a push portion which is pushed down by a finger is formed at a position spaced apart from the hinge point, and the push grip is rotated around the hinge point by a force applied to the push portion, so that a release cable is operated to release locking of a door latch.

The push grip may be installed in a mounting space portion which is recessed inwardly in the door trim, with a stepped portion being formed between the door trim and the push grip, and the push grip may have an assembled position which is placed on an outside of a vehicle relative to a protruding surface of the door trim and a protruding surface of the inner panel.

When the push grip is pushed down, the push grip may be rotated around the hinge point, and downward movement of the push grip may be guided by a moving path in which the push grip is brought in surface contact with a panel surface provided by one of panels forming the door. A slope of the movement path may be inclined toward an inside of the door trim, and the movement may have a radius of curvature which is a distance from the hinge point.

The slope of the movement path may be defined by a portion of the push grip.

The push grip may include a rectangular grip body, a push surface which is formed on a portion of the grip body with a stepped portion to form a space in which a finger is put, a cable coupling member which is connected with the release cable extending from the portion of the grip body to the door latch on the basis of the push surface, a hinge pin which is formed on an end portion of the grip body and functions as the hinge point of the grip body, a return spring which resiliently supports the grip body having the cable coupling member to provide a resilient restoring force to the grip body, and a guider which is provided on the end portion of the grip body having the cable coupling member.

The guider may form an inclined angle along a vertical distance of a terminal surface of the protruding surface, so that the grip body is moved downward while being brought in surface contact with a panel surface provided by one of the panels forming the doors, and a curvature may be formed along the vertical distance of the terminal surface, so that the grip body is pivoted around a rotational center axis of the hinge point.

The guider may be inserted into a guide groove of a door trim cover which overlaps the grip body positioned on the door trim.

The push grip may further include a safety button which is connected to a safety cable extending to the door latch to maintain the locking state.

The safety button may be provided on a button coupling member of the grip body, and a cable coupling member which is connected with the release cable extending to the door latch may be provided at a position opposite to the button coupling member.

The push grip may be covered by an assembly finishing member which is engaged with the mounting space portion of the door trim.

The assembly finishing member may include a cover bracket which overlaps a portion of the push grip and is engaged with the door trim, a vessel which is positioned on the push grip which is not overlapped by the cover bracket, and a door trim cover which covers the vessel and the cover bracket and forms a stepped portion on a portion of the rectangular grip body of the push grip to expose a push surface of the push grip in which a finger is put.

Various aspects of the present invention provide for a push-type interior door handle including a push grip which is arranged along a vertical direction of a door trim forming a door together with an outer panel and an inner panel, in which one end portion is connected to the door trim to form a hinge point, and a push portion which is pushed down by a finger is formed at a position spaced apart from the hinge point, and in which the push grip is rotated around the hinge point by a force applied to the push portion, so that a release cable is operated to release locking of a door latch; a safety button which is connected to a safety cable extending to the door latch to maintain a locking state; a cover bracket which overlaps a portion of the push grip and is engaged with the door trim; a vessel which is positioned on the push grip which is not overlapped by the cover bracket; and a door trim cover which covers the vessel and the cover bracket and forms a stepped portion on a portion of the rectangular grip body of the push grip to expose a push surface of the push grip in which a finger is put.

With the above configuration of the present invention, since the interior door handle for releasing the locking of the door latch by the pushing operation has a long hinge distance using the door trim, the door can be opened by about 70% of an operating force of a leverage type interior door handle which is operated by a finger.

Also, since the interior door handle having a long hinge for unlocking operation of the door latch is formed together with the door trim, the locking of the door latch is released by only pushing operation, so that the door is conveniently opened by only one-touch push operation. In particular, since a handle grip is not provided, the door can be operated by a palm or arm.

In addition, since the interior door handle having a long hinge for unlocking operation of the door latch is formed together with the door trim, occupants having a relatively weak joint or finger disability can manipulate the door open by only the one-touch push operation of pressing a push surface down. In particular, if the interior door handle is installed in vehicles for disabled person, he or she can conveniently open the door by himself or herself, with no help from any one.

Since the interior door handle for releasing the locking of the door latch is operated by pushing it from top to bottom, it is possible to prevent unexpected wrong operation of the door due to a fact in which a shoulder or arm of the occupant leans against a portion of the door trim, thereby reinforcing the safety.

Furthermore, since the interior door handle having a long hinge for unlocking operation of the door latch is formed together with the door trim, interior design of the door can be preferably embodied, and occupants can easily catch the locking state of the door through the locking state display of the door.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A, 1B and 1C are diagrams illustrating the configuration of an exemplary push-type interior door handle which is formed integrally with a door trim according to the present invention.

FIGS. 2 and 3 are diagrams illustrating the configuration of an exemplary push grip of the push-type interior door handle according to the present invention.

FIGS. 4A and 4B are diagrams illustrating an exemplary disassembled state and mounting state of the push-type interior door handle according to the present invention.

FIG. 5A and 5B are diagrams illustrating an exemplary operation state of the push-type interior door handle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

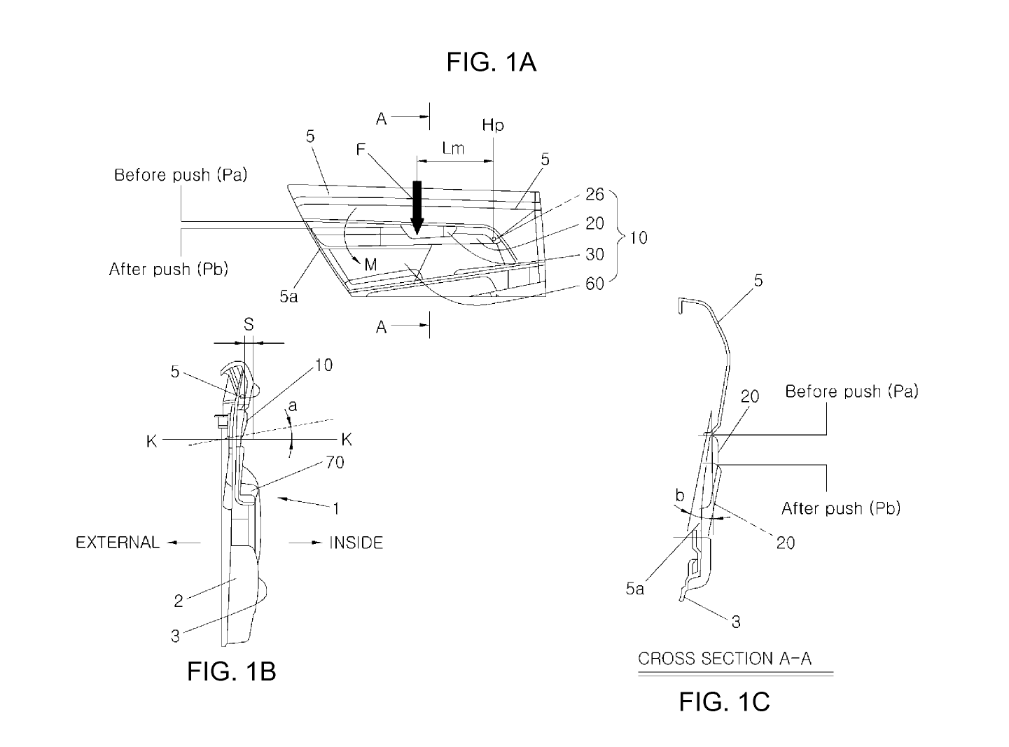

FIG. 1 illustrates the configuration of a push-type interior door handle which is formed integrally with a door trim according to various embodiments of the present invention.

As illustrated in the drawing, a door 1 provides a space, in which a window regulator and a motor are mounted, between an outer panel 2 and an inner panel 3. A push-type interior door handle 10 is installed on a door trim 5, which forms an upper portion of the door 1, from an upper side of the inner panel 3.

The interior door handle 10 prevents unwanted door opening operation due to unintended contact of an occupant. The interior door handle 10 is adapted to open the door only by simple manipulation in which a finger of a user is pushed down. To the end, a coupling structure of the interior door handle 10 uses the shape of the door trim 5.

More specifically, the interior door handle 10 is installed in a mounting space portion 5a which is recessed inwardly in the door trim 5, with a stepped portion S being formed between the door trim 5 and the interior door handle 10, so that it is achieved to prevent the door from being unintentionally opened due to the unintended contact.

Due to the above-described stepped portion S, the interior door handle 10 can be placed at a position which is recessed toward the outside of the vehicle with respect to the inner panel 3 and the door trim 5 which form the inner surface of the door 1.

Therefore, since a shoulder or arm of the occupant does not come in contact with the interior door handle 10 even though the occupant leans against a portion of the door trim 5, it is possible to prevent unexpected wrong operation of the door, thereby significantly enhancing its safety.

In addition, the door opening operation through the simple push motion is achieved by the fact that the interior door handle 10 is connected to the door trim 5 to a hinge point Hp at only one end portion of the whole length.

To this end, the interior door handle 10 is provided with a hinge pin 26 which is connected to the door trim 5 to function as the hinge point HP forming a rotational center.

By the above-described hinge point HP, the interior door handle 10 can form a moment distance Lm in a position to which a pushing force F is applied. The moment distance Lm forms rotational motion M of the interior door handle 10 against the pushing force F.

In this way, the moment (M=F×Lm) of the interior door handle 10 can be created to have a value larger than that of a conventional leverage type interior door handle. As a result, it can open the door 1 with a relatively weak force.

The motion of the interior door handle 10 is shown by a pre-pushing position Pa and a post-pushing position Pb.

In particular, if the interior door handle 10 is assembled to the door 1, the interior door handle 10 can rotate by about 2.5 to 3 degrees around a rotational center axis K-K, which is formed by the hinge point Hp, to form a rotational angle α. The interior door handle 10 is installed to have a mounting inclined angle b of about 8 degrees with respect to a vertical surface of the inner panel 3 which forms the door 1.

To this end, the interior door handle 10 is provided with a guider 28 which will be described later.

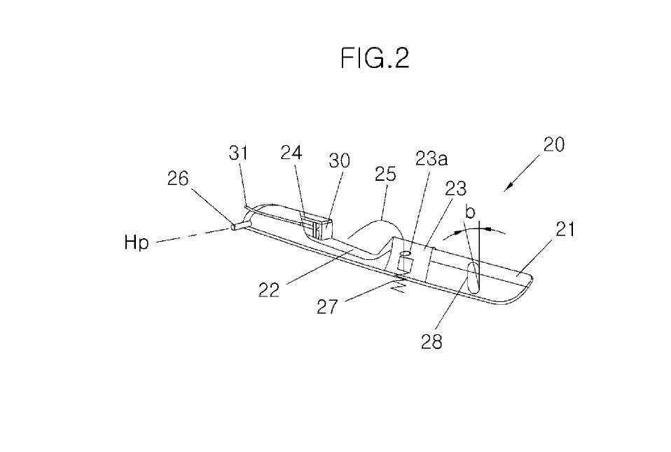

FIG. 2 illustrates the configuration of a push grip which forms the push-type interior door handle according to various embodiments of the present invention.

As shown in the drawing, the interior door handle 10 includes a push grip 20 which is hingedly connected to the door trim 5 and is pushed down to unlock the door 1, a safety button 30 which is provided as one portion of the push grip 20 and maintains the locking state of the door 1, and a door latch which is built in the door 1 and is connected to a release cable 25 coupled to the push grip 20 and also connected to a safety cable 31 coupled to the safety button 30.

The push grip 20 includes a rectangular grip body 21 which is made from plastic through injection molding, a push surface 22 which is formed on a portion of the grip body 21 with a stepped portion to form a space in which a finger is put, a cable coupling member 23 which is connected with the release cable 25 extending from the one portion of the grip body 21 to the door latch 70 on the basis of the push surface 22, a button coupling member 24 which is connected to the safety cable 31 extending to the door latch at other portion of the grip body 21 on the basis of the push surface 22, a hinge pin 26 which is formed on an end portion of the grip body 21 together with the button coupling member 24 and functions as the hinge point Hp of the grip body 21, a return spring 27 which resiliently supports the grip body 21 having the cable coupling member 23 to provide a resilient restoring force to the grip body 21, and a guider 28 which is provided on an end portion of the grip body 21 having the cable coupling member 23 to guide downward movement of the grip body 21 pushed down.

The cable coupling member 23 is provided with a boss 23a for connecting the release cable 25, which extends to the door latch 70, in a stationary state. A button coupling member 24 is provided with a boss or a protrusion for connecting the safety cable 31, which extends to the door latch 70, in a stationary state.

The door latch 70 is a conventional door latch including latch mechanisms for maintaining the door locking and also releasing the door locking.

In particular, the grip body 21 is installed on the door trim 5 provided with the mounting space portion 5a which is recessed toward the outside of the vehicle, so that the grip body is installed to have a mounting angle b of about 8 degrees with respect to a vertical surface of the inner panel 3 which forms the door 1 in the state in which it is assembled to the mounting space portion 5a.

As a result, since the grip body 21 is not pushed down even though the shoulder or arm of the occupant leans against a portion of the door trim 5, the unexpected wrong operation of the interior door handle 10 is prevented, thereby significantly enhancing its safety.

In addition, the grip body 21 forms the moment distance Lm from the hinge pin 26 forming the hinge point Hp to the push surface 22 pushed by the finger, thereby operating the release cable 25, which extends to the door latch, with rotational movement M larger than the force pushing the grip body 21.

If the grip body 21 is pushed down, the interior door handle 10 rotates around the rotational center axis K-K, which is formed by the hinge point Hp, at about 2.5 to 3 degrees to release the door locking.

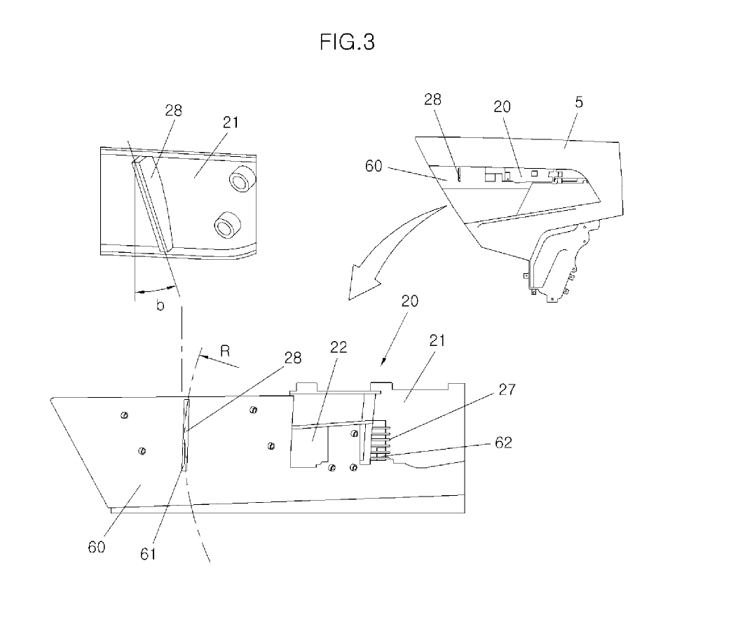

FIG. 3 illustrates a coupling structure formed by the guider 28 of the grip body 21 and the movement of the grip body 21 through the guider 28.

As illustrated in the drawing, the guider 28 is formed integrally with the grip body 21, and forms the mounting angle b of about 8 degrees. As a result, the guider 28 can maintain a surface contact with the door trim 5 or the inner panel 3 forming the door 3 in the state in which the grip body 21 is assembled, and the interior door handle 10 can be assembled to the vertical surface of the inner panel 3 at an inclined angle of about 8 degrees.

Herein, the slope of about 8 degrees means the inclined angle of the terminal surface of the guider 28 extending from top to bottom.

In addition, the guider 28 protrudes to have a radius R of curvature of which the hinge point Hp is centered. When the push grip 20 is pushed down, the rotational movement around the hinge point Hp occurs in a downward direction, and the interior door handle 10 is rotated at about 2.5 to 3 degrees by the rotational movement to release the door locking.

In various embodiments, the inner panel 3 or the door trim 5 which is brought in surface contact with the guider 28 to assemble the guider 28 may be provided with a guide groove which is equal to or slightly larger than a cross-sectional width of the guider 28.

To this end, the door trim cover 60 is provided with a guide groove 61 in which the guider 28 is inserted.

In addition, the door trim cover 60 may be further provided with a spring boss 62 to which the return spring 27 providing the resilient restoring force to the grip body 21 is coupled.

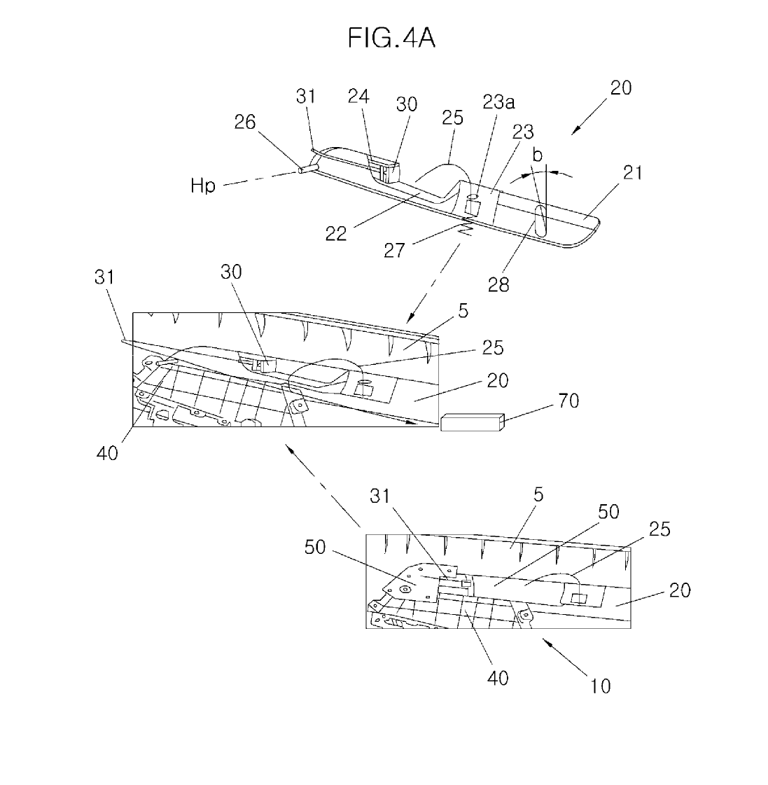

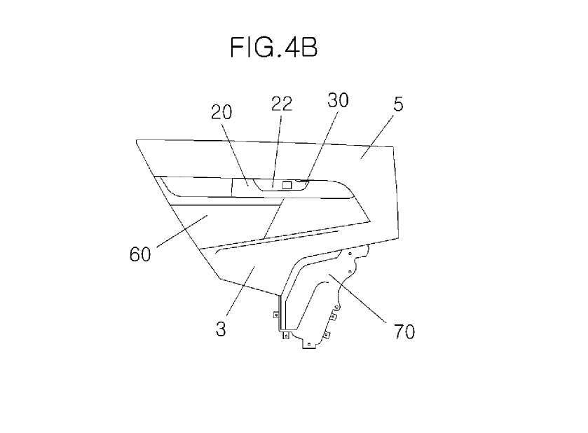

FIG. 4A illustrates a disassembled state of the push-type interior door handle according to the present invention. The push-type interior door handle according to various embodiments is further provided with an assembly finishing member. The assembly finishing member is mounted on the inner panel 3, the door trim 5, and the push grip 20.

To this end, the assembly finishing member includes a cover bracket 40 which overlaps a portion of the push grip 20 and is engaged with the door trim 5, a vessel 50 which is positioned on the push grip 20 which is overlapped by the cover bracket 40, and a door trim cover 60 which is positioned in the mounting space portion 5a recessed in the door trim 5 to cover the vessel 50 and the cover bracket 40 and exposes the push surface 22 of the push grip 20.

FIG. 4B illustrates the interior door handle 10 which is assembled with the assembly finishing member. As illustrated in the drawing, when the interior door handle 10 is completely assembled, all portions of the push grip 20 are covered by the door trim cover 60, except for the push surface 22, so that the interior door handle is finished to have a tidy appearance.

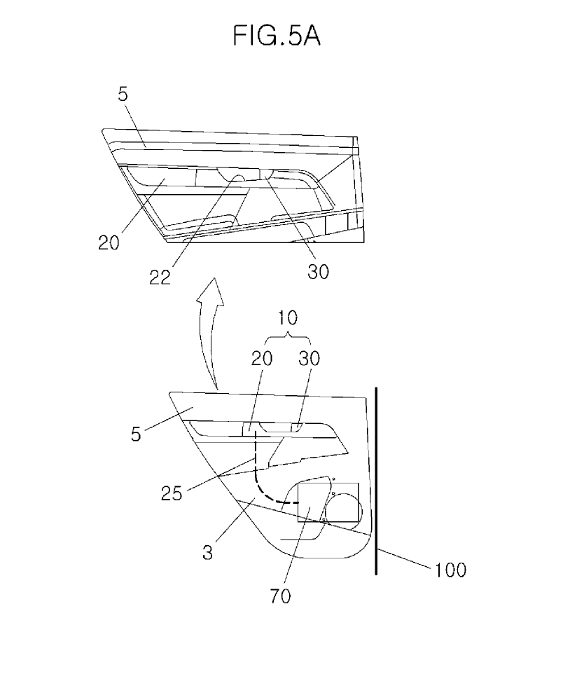

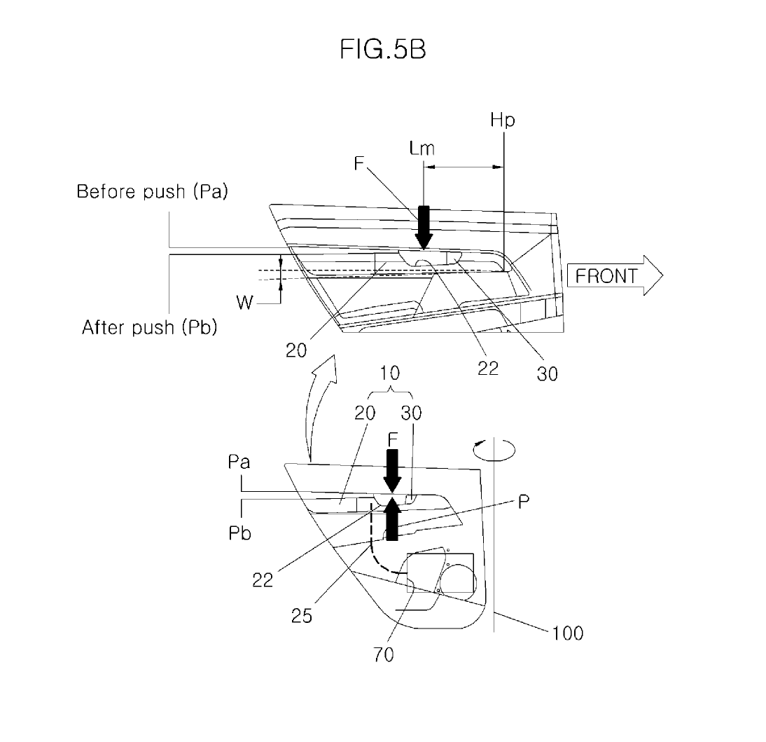

Meanwhile, FIG. 5 illustrates the operation state of the interior door handle 10 according to various embodiments which is assembled to the door.

FIG. 5a illustrates the state in which the interior door handle 10 is not operated. The push grip 20 is maintained in the non-pushed state, and the release cable 25 extending from the push grip 20 to the door latch is not operated, so that the door latch is maintained in the lock state.

In this instance, the interior door handle 10 is not operated, and thus the door is maintained in the lock state.

When the safety cable 31 is operated by pushing the safety button 30 down, the door latch connected to the safety cable 31 is maintained in the lock state even when the push grip 20 is pushed down. As a result, it is possible to prevent a safety accident due to door open above a predetermined vehicle speed.

Such a function prevents the door from being opened by manipulation of a child when the vehicle is traveled at a predetermined vehicle speed or more. The function is similar to a safety function which is generally applied to the door handle.

On the other hand, FIG. 5b illustrates the operation state of the interior door handle 10. By only operation in which the exposed push surface 22 is slightly pressed down by the finger to apply the push force F, the push grip 20 is moved down around the hinge point Hp.

In this instance, the downward movement of the push grip 20 is guided through the inclined angle of the guide 28, and then is moved in the door trim 5 at the slope of about 8 degrees. Simultaneously, the push grip is rotated around the rotational center axis K-K of the hinge pin 26 at an angle of about 2.5 to 3 degrees by the curvature of the guide 28.

By the movement of this push grip 20, the return spring 27 which resiliently supports the push grip 20 is compressively deformed, and the compressive transformation of the return spring 27 provides the resilient restoring force to return the push grip 20 to the initial position.

As described above, if the push grip 20 is moved from the pre-pushing position Pa to the post-pushing position Pb to be in the release moving state W, the release cable 25 extending from the push grip 20 to the door latch 70 is operated, so that the door latch 70 is unlocked.

At that time, the operation of releasing the door latch 70 by the release cable 25 is an operation of the conventional door latch.

In this instance, since the interior door handle 10 is in the operation station, the door 1 is switched in the state in which it can be opened.

When power P to slightly push the door 1 outward from the vehicle with the finger or palm is applied to the door, the door 1 is opened around the door hinge 100 as a rotational shaft.

For convenience in explanation and accurate definition in the appended claims, the terms upper, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An interior door handle of a vehicle door that includes a door trim, a door latch, an inner panel and an outer panel, the interior door handle comprising:
a push grip mounted along the door trim of the vehicle door to move in a vertical direction;
wherein one end portion of the push grip is pivotally connected to the door trim at a hinge point, and a push portion of the push grip configured to be pushed down by a finger is spaced from the hinge point; and
wherein the push grip rotates around the hinge point by a force applied to the push portion to operate a release cable to release locking of the door latch.

2. The interior door handle of claim 1, wherein the push grip is installed in a mounting space portion of the door trim recessed inwardly of the inner panel, with a stepped portion being formed between the door trim and the push grip, and the push grip has an assembled position placed on an outside of a protruding surface of the door trim and a protruding surface of the inner panel.

3. The interior door handle of claim 2, wherein when the push grip is pushed down, the push grip is rotated around the hinge point, and downward movement of the push grip is guided by a moving path in which the push grip is brought in surface contact with a panel surface provided by one of panels forming the door, and a slope of the movement path is inclined toward an inside of the door trim, and the movement has a radius of curvature which is a distance from the hinge point.

4. The interior door handle of claim 3, wherein the slope of the movement path is defined by a portion of the push grip.

5. The interior door handle of claim 1, wherein the push grip includes a rectangular grip body, a push surface formed on a portion of the grip body with a stepped portion to form a space in which a finger is put, a cable coupling member connected with the release cable extending from the portion of the grip body to the door latch on the basis of the push surface, a hinge pin formed on an end portion of the grip body and functions as the hinge point of the grip body, a return spring which resiliently supports the grip body having the cable coupling member to provide a resilient restoring force to the grip body, and a guider provided on the end portion of the grip body having the cable coupling member.

6. The interior door handle of claim 5, wherein the guider forms an inclined angle along a vertical distance of a terminal surface of the protruding surface, so that the grip body is moved downward while being brought in surface contact with a panel surface provided by one of the panels forming the doors, and a curvature is formed along the vertical distance of the terminal surface, so that the grip body is pivoted around a rotational center axis of the hinge point.

7. The interior door handle of claim 6, wherein the guider is inserted into a guide groove of a door trim cover which overlaps the grip body positioned on the door trim.

8. The interior door handle of claim 1, wherein the push grip further includes a safety button connected to a safety cable extending to the door latch to maintain the locking state.

9. The interior door handle of claim 8, wherein the safety button is provided on a button coupling member of the grip body, and a cable coupling member connected with the release cable extending to the door latch is provided at a position opposite to the button coupling member.

10. The interior door handle of claim 8, wherein the push grip is covered by an assembly finishing member engaged with the mounting space portion of the door trim.

11. The interior door handle of claim 10, wherein the assembly finishing member includes a cover bracket which overlaps a portion of the push grip and is engaged with the door trim, a vessel positioned on the push grip which is not overlapped by the cover bracket, and a door trim cover which covers the vessel and the cover bracket and forms a stepped portion on a portion of the rectangular grip body of the push grip to expose a push surface of the push grip in which a finger is put.

12. A interior door handle comprising:
a push grip mounted along a door trim of a vehicle door including inner and outer panels, the push grip including one end portion pivotally connected to the door trim at a hinge point, and a push portion of the push grip configured to be pushed down by a finger is spaced apart from the hinge point, and in which the push grip is rotated around the hinge point by a force applied to the push portion, so that a release cable is operated to release locking of a door latch;
a safety button connected to a safety cable extending to the door latch to maintain a locking state;
a cover bracket which overlaps a portion of the push grip and is engaged with the door trim;
a vessel positioned on the push grip which is not overlapped by the cover bracket; and
a door trim cover which covers the vessel and the cover bracket and forms a stepped portion on a portion of the rectangular grip body of the push grip to expose a push surface of the push grip adapted for receiving the finger.

13. The interior door handle of claim 12, wherein
the push grip has a relatively recessed position relative to a protruding surface of the door trim and a protruding surface of the inner panel;
when the push grip is rotated around the hinge point, the push grip is moved downward along a downward movement path in which the push grip is brought in surface contact with a panel surface provided by one of panels forming the door; and
the downward movement path has a downward slope so that a protruding position to the door trim is recessed, and has a curvature so that the push grip is downward rotated around a rotational center axis of the hinge pin and then enters the door trim.

14. The interior door handle of claim 12, wherein the push grip includes a rectangular grip body, a push surface formed on a portion of the grip body with a stepped portion to form a space in which a finger is put, a cable coupling member connected with the release cable extending from the portion of the grip body to the door latch on the basis of the push surface, a safety button connected to a safety cable extending to the door latch at a position opposite to the grip body on the basis of the push surface, a hinge pin formed on an end portion of the grip body and functions as the hinge point of the grip body, a return spring which resiliently supports the grip body having the cable coupling member to provide a resilient restoring force to the grip body, and a guider provided on the end portion of the grip body having the cable coupling member.
